(19) United States
(12) Patent Application Publication
(10) Pub. No.: US 2023/0234341 A1
(43) Pub. Date: Jul. 27, 2023

(54) MULTI-LAYER RESEALABLE TAMPER-EVIDENT FILM FOR PACKAGING

(71) Applicants: BOSTIK, INC., Wauwatosa, WI (US); TERPHANE LLC, Bloomfield, NY (US)

(72) Inventors: Kasra MIRMESDAGH, Wauwatosa, WI (US); Ellen SMITH, Bloomfield, NY (US)

(73) Assignees: BOSTIK, INC., Wauwatosa, WI (US); TERPHANE LLC, Bloomfield, NY (US)

(21) Appl. No.: 17/918,917

(22) PCT Filed: Apr. 14, 2021
(86) PCT No.: PCT/US2021/027172

§ 371 Date: Oct. 14, 2022

Related U.S. Application Data
(60) Provisional application No. 63/010,418, filed on Apr. 15, 2020.

(51) Int. Cl. B32B 27/08; B32B 7/03; B32B 7/12; B32B 27/36; B32B 27/30; B32B 37/15

(52) U.S. Cl. CPC B32B 27/08; B32B 7/03; B32B 7/12; B32B 27/36; B32B 27/302; B32B 37/153; B32B 2250/03; B32B 2307/518; B32B 2439/70; B32B 2255/26; B32B 2264/1021; B32B 2250/42; B32B 2037/1276

(57) ABSTRACT

A multilayer film comprising, in this order:
(a) a biaxially oriented polyethylene terephthalate layer,
(b) a pressure sensitive adhesive layer,
(c) an elastic polyurethane dispersion, and
(d) a biaxially oriented polyethylene terephthalate layer.

Layer (d) preferably has the structure A:B:A:C; where A and B preferably comprise crystalline PET and antiblocking particles and C is preferably an amorphous, heat-sealable copolyester.

### CROSS-REFERENCE TO RELATED APPLICATION

This application claims the benefit under 35 U.S.C. § 119(e) of U.S. Patent Application No. 63/010,418, filed on Apr. 15, 2020.

### SUMMARY OF INVENTION

The present invention provides a polyester film useable to provide a tamper-evident, resealable lidding component for packaging. Resealable packaging has become popular especially in the area of foodstuffs for its advantages of providing to the consumer a product container eliminating the need to transfer leftovers to another storage receptacle.

Multilayer films used in the peelable and/or resealable packaging field are known, for example, in US 2018/0215522, assigned to BOSTIK SA, and in U.S. Pat. No. 7,413,800, assigned to Terphane, Inc. Resealable packagings are used in the food-processing industry and mass marketing for packaging perishable foods, in particular fresh products. These packagings generally comprise a container (or receptacle) and a seal forming a lid, which are hermetically attached to one another by welding. After the seal has been opened for the first time and a portion of the food product contained in the receptacle has been consumed, the user can reposition the seal on the receptacle, so as to reseal the packaging substantially hermetically, and to consequently, as appropriate, after placing it in a refrigerator, store the remaining portion of the product. A sequence of reopenings and resealings is also possible.

Multilayer films used in resealable packaging systems should allow an easy first opening and satisfactory reclosing/reopening cycles. For example, easy first opening can be achieved by an initial peel strength measured as the application of a force of less than or equal to 15 N/cm, preferably 7 N/cm or less, and with a propagation force, once the package has been opened, of preferably about 3 to 11 N/cm, more preferably 4 to 11 N/cm. The film also preferably enables an easy self-adhering reclosure of the packages, that is to say easy manual repositioning of the two parts of the film after a series of closing/reopening operations, with reopening forces of greater than 1 N/cm, preferably greater than or equal to 2 N/cm, more preferably 2-4 N/cm.

Many current resealable lidding structures or films employ either a peelable label adhered to a non-removable lid or, where it is desired to allow removal of a larger portion of the product cover, die-cutting an opening. These films are typically produced by laminating a heat sealable biaxially oriented polyethylene terephthalate (BOPET) film to a printable BOPET web with a water-based pressure sensitive adhesive (PSA) coating. The heat sealable layer is then laser scored or die cut to provide an opening into the container. Due to the technologies required to produce this structure, multiple conversion steps are typically required for production. This results in long lead times and an expensive packaging cost typically passed along to consumers. Moreover, water-based PSAs have low moisture resistance which may result in package failures. The laser scoring leaves a ribbon of film around the edge of the tray rim limiting access to the foodstuff inside.

It would accordingly be preferable to have packaging where the entire lid functioned as a peelable opening, allowing greater access to the container, and allowing avoidance of the additional cost and process steps of die-cutting.

In addition, few current resealable lids offer tamper evidence. If it is desired to have resealable packaging which is tamper-evident, it may be necessary to affix an additional label closure which is broken or not resealable once removed, to serve notice that the package has been opened, requiring additional steps and cost.

The present invention provides a multilayer film that can be used to form resealable packaging. The film can be used to form an entire lid of a tray, for example, avoiding the necessity for having just a peelable label, and further avoiding the need for die-cutting of an opening. In addition, the film provides a tamper-evident feature allowing consumers to know if the package has been opened.

The invention provides a film comprising (a) a biaxially-oriented polyethylene terephthalate (BOPET) layer, (b) a pressure sensitive (PSA) layer, (c) a layer of dispersed polyurethane particles, and (d) a BOPET layer. BOPET layer (a) is optionally printable, so that product information can be provided to a consumer. Layers (a) to (d) are in the above order, and typically adjacent to each other, preferably without additional internal layers.

In principle, any BOPET film can function as layer (a). BOPET films are well known as disclosed in, e.g., U.S. Pat. Nos. 2,823,421 and 2,884,663. Layer (a) may receive a corona and/or a coex treatment to improve adhesion of inks and adhesives. The corona treatment can be a pretreatment of the film layer (a) prior to supplying the film to the lamination apparatus or can be a “bump” corona treatment where a corona treater is present on the production line and effects treatment prior to application of adhesive and lamination. Corona treatment can also be a combination of pretreatment and bump treatment. Preferred BOPET films are surface-treated to increase adhesion. Representative surface-treated films are disclosed in, e.g., U.S. Pat. Nos. 4,476,189 and 5,985,437. Surface-treated BOPET films suitable as layer (a) are also commercially available, for example, from Terphane LLC, and include Terphane 10.21 (one side COEX treated), 10.25 (one side COEX, one side corona treated) and 10.15 (one side corona treated). Layer (a) may have a thickness of 2-100 μm, or 5-50 μm, or 10-40 μm, for example.

Preferred pressure sensitive adhesives include styrene block copolymers obtained from styrene monomers and from at least one other comonomer, such as ethylene, propylene, isoprene, butadiene and butylene. The copolymers can possess a linear, radial or star-shaped, diblock, triblock or multiblock structure, with an intermediate block of at least one of the above comonomers. These PSAs further contain a tackifier such as an aliphatic resin enhancing compatibility between the styrene and non-styrene blocks of the block copolymer. Such resins include polyterpenes, polymers from C5 cuts, optionally modified by C9 cuts, polymers from partially or completely hydrogenated C9 cuts optionally modified by aliphatic cuts. The PSA typically contains 45 to 85%, preferably 55 to 70%, by weight of copolymer or a blend of copolymers and 15 to 60%, preferably 30 to 45%, by weight of tackifying resin or a blend of tackifying resins. The adhesive may also contain a small fraction of a plasticizer, a stabilizer or a filler, these being additives conventionally used in hot-melt adhesives. Thus, typical PSAs contain a blend of at least one styrene block copolymer and at least one compatible tackifying resin.

Preferably, such a blend has, at between −20 and +40° C., an elastic modulus G′<5×10⁵ Pa (Dahlquist criterion), a viscosity n (measured according to the ISO 11443 standard), at a temperature of at least 130° C.
and for a shear rate dy/dt of between 100 and 1,000 s⁻¹, lying within a range located above the curve (See FIG. 1) and a tensile strength for a pull rate of 1 ms⁻¹ lying within a range located below the average curve (See FIG. 2) as defined by the polynomial equation: y=−2.82×10¹⁶ x⁶+5.92×10⁻¹³ x⁵−4.97×10⁻¹⁰ x⁴+2.15×10⁻⁷ x³−4.99×10⁻⁵ x²+6.26×10⁻³ x+4.71×10⁻², in which y—the ordinate—represents the stress expressed in MPa and x—the abscissa—represents the deformation expressed as a percentage (%).

Particularly preferred pressure sensitive adhesives are those comprising a blend of:
40-85 wt % of at least one styrene block copolymer formed from at least one styrene monomer and at least one other comonomer (preferably isoprene, butadiene, butylene, or a combination thereof, more preferably isoprene or butadiene, and most preferably isoprene forming an SIS block copolymer), and comprising:
   a mass percentage of the styrene phase in the polymer of between 10 and 35%, preferably between 10-25%; and
   a mass percentage of diblock in the polymer of greater than 30%, preferably greater than 40%; and
15 to 60 wt % of at least one compatible tackifying resin having a softening temperature between 5 and 150° C. Such an adhesive has a melt flow index of between 2 and 70 g/10 min. at 190° C. using a 2.16 kg weight.

In particular, the PSA has the following properties:
a viscosity, at a temperature of at least 130° C., lying within a range located above the power curve of η=22 000×(dy/dt+200)^{-0.82} wherein dy/dt comprises a shear rate between 100 and 1,000 s⁻¹;
a tensile strength at a pull rate of 1 ms⁻¹ within the range located below the polynomial curve y=−2.82×10⁻¹⁶ x⁶+5.92×10⁻¹³ x⁵−4.97×10⁻¹⁰ x⁴+2.15×10⁻⁷ x³−4.99×10⁻⁵ x²+6.26×10⁻³ x+4.71×10⁻²,
   wherein y comprises an ordinate representing the stress expressed in MPa and x comprises an abscissa representing the deformation expressed in %;
an elastic modulus G′<5×10⁵ Pa at −20 to +40° C.;
an adjusted cold cohesion such that the hot-extrudable pressure sensitive adhesive is capable of exhibiting predominately cohesive failure during the first opening.

Thickness of the PSA layer is preferably 5-35 μm, more preferably 5-22 μm.

In an embodiment prior to extrusion, the adhesive is in the form of pellets or granules at room temperature.

Suitable pressure sensitive adhesives are disclosed in U.S. Pat. No. 7,622,176.

Layer (c) is applied as a dispersion of elastic polyurethane particles and then dried or cured. Such dispersions are known as haptic coatings, used on the outer surface of films, to provide a soft-touch sensation. Such coatings are disclosed, for example, in U.S. Pat. No. 10,428,237, and are also commercially available, e.g., NeoRez® R-1030 from DSM Coating Resins B.V., Purkote™ 23593 from Ashland Inc. and 191230PX® from Michelman Inc. Thickness of the polyurethane layer may vary over a wide range, and typically is 0.1-5 μm, preferably 0.1-3 μm. Layer (c) may be referred to herein as an elastic polyurethane dispersion.

Layer (d) is preferably a “specialty” BOPET, comprising a multi-layer film of biaxially-stretched polyethylene terephthalate having an A:B:A:C structure, in which:
The A and B layers are composed of crystalline PET containing inorganic anti-blocking particles such as silica, calcium carbonate, glass beads, kaolin, or mixtures of 2 or more of these ingredients, with silica being preferred, and the B layer optionally contains reground PET;
The C layer is composed of an amorphous heat sealable copolyester. The copolyester is preferably an amorphous polyester resin such as an ethylene terephthalate copolymer prepared by the condensation of dimethyl terephthalate or terephthalic acid with one or more of the following: azelaic acid, dimethyl azelate, dimethyl sebacate, sebacic acid, isophthalic acid, 5-sodiumsulfoisophthalic acid, or by the condensation of dimethyl terephthalate or terephthalic acid with ethylene glycol, diethylene glycol and/or cyclohexanedimethyl glycol. Preferred copolyesters are of isophthalic acid, terephthalic acid and monoethylene glycol (MEG)/diethylene glycol (DEG). Representative copolyesters are disclosed in U.S. Pat. No. 7,413,800.
The C layer may also include one or more anti-fog agents, including but not limited to glycerol monostearate or sodium dodecylbenzene sulfonate.

In the preferred BOPET of layer (d), the content of layers (A) is preferably 10 to 15% based on total thickness of layer (d), more preferably about 13%, and each layer (A) preferably contains 200 to 300 ppm of antiblocking agent; the content of layer (B) is preferably 61 to 78% based on total thickness of layer (d), more preferably about 69%, and preferably contains 90-215 ppm antiblocking agent; the content of layer (C) is preferably 12 to 24% of total thickness of layer (d), more preferably about 18%, and preferably contains 150 to 250 ppm of antiblocking agent. Layers (A) and (B) preferably have a combined thickness of 2-100 μm. Layer (C) preferably has a thickness of 0.1 to 10 μm. Layer (d) preferably has an overall combined thickness of layers (A), (B) and (C) of 2-110 μm, preferably from 4-15 μm, more preferably from 6-10 μm, preferably 8 μm.

Biaxial orientation of BOPET layer (d) can be achieved subsequent to coextrusion of the layer by high temperature stretching of the film, e.g., at 226-238° C., preferably at 238° C. The film is stretched in the transverse direction/machine direction (TD/MD) 300-400%, preferably 350%.

In an embodiment, BOPET layer (a) and/or heat sealable BOPET layer (d) may also be coated with a barrier coating in order to reduce permeability of the film to gases such as oxygen, nitrogen, and other gases, a mixture of gases, moisture vapor, and/or odors. Representative barrier coatings may be found in the group of organic barrier polymers and filled polymers, which include vinylidene chloride polymers and copolymers, such as PVDC, PVOH or EVOH based coatings (such as described in U.S. Pat. No. 10,392,527 and US 2017/0210867), polyurethane coatings, or other water-based, solvent-based, or UV/EB cured coatings. The barrier coating may be reinforced with nanosized additives, such as mica, vermiculite, nanofibers, or others, in order to enhance its barrier properties, such as described in U.S. Pat. No. 8,080,297. The barrier coating may be prepared from dispersions, or solutions, and then coated onto the film surface, and sequentially dried using any known coating method, including but not limited to gravure, flexo, offset, spray, and dipcoating. Other barrier coatings may result from metallic, ceramic or organic deposition, such as aluminum, aluminum oxide, silicon oxide, melamine, among others. Such coatings may be deposited by any known coating method, including but not limited to spraying, thermal evaporation, sputtering, chemical vapor deposition, and atomic layer deposition. See also U.S. Pat. No. 7,413,800, discussing barrier coatings at col. 4, lines 18-24.

### BRIEF DESCRIPTION OF THE DRAWINGS

FIG. 1 shows the lower viscosity limit of the PSA in terms of viscosity (Pas) versus shear rate (1/s) for an embodiment of the invention.

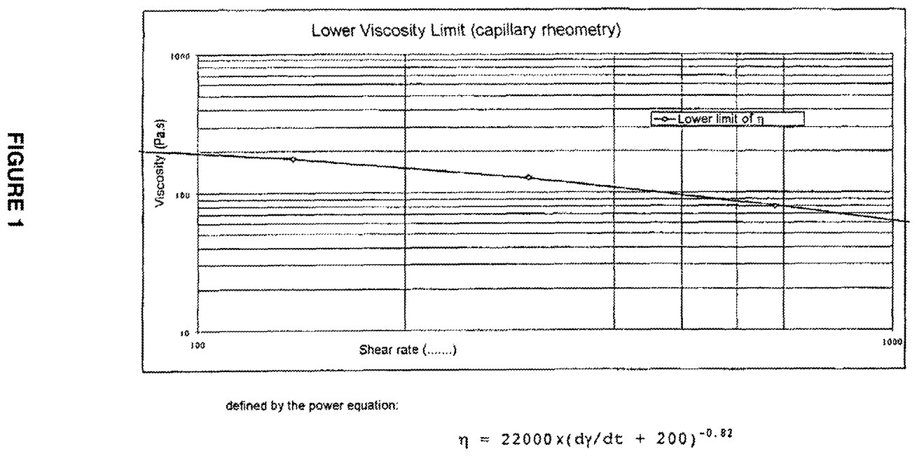

FIG. 2 shows the upper limit of tensile strength of the PSA for a pull rate of 1 m/s in terms of stress versus percent deformation for an embodiment of the invention.

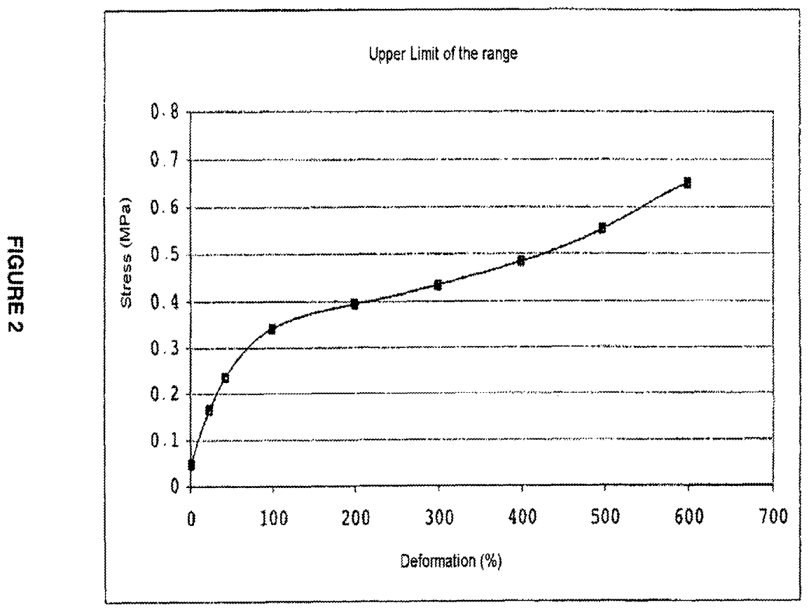

FIG. 3 is a representation of a closed container having the film of the invention as a sealing member.

FIG. 4 shows a container having the film of the invention as a sealing member, after opening.

FIG. 5 shows an extrusion lamination process used to prepare the films.

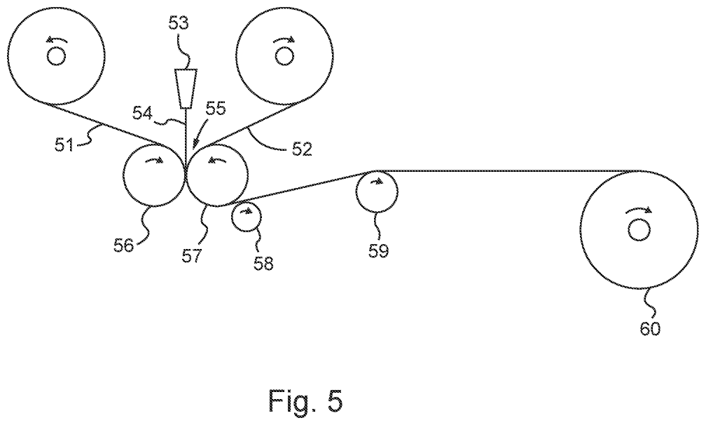

The multilayer film of the invention can be produced by coextrusion of the layer (d) BOPET, separate coextrusion of layer (a) BOPET, gravure coating of the layer (c) polyurethane dispersion on layer (d) BOPET, and extrusion laminating layer (d) BOPET to layer (a) BOPET with layer (b) PSA as the adhesive. In extrusion lamination, as shown in FIG. 5, an adhesive (54) (in this case, PSA layer (b), the styrene block copolymer), is extruded onto a moving substrate (in this case, BOPET layers (d) and (a), represented by (51) and (52)) through a flat die (53). The layer (c) polyurethane dispersion can be coated in-line with the extrusion lamination, upstream of the flat die (53), or can be coated off-line so that it is already on BOPET layer (d) when fed to the extrusion lamination process (as depicted in FIG. 5). At least the side of the layer (a) BOPET that will contact the (b) PSA can be corona treated in-line with the extrusion lamination, upstream of the flat die (53), to increase the adhesion of the (b) PSA to the layer (a) BOPET. The polymer melt exits the die typically at a high temperature, typically 150 to 330° C., preferably in an embodiment 150 to 190° C. After exiting the die the polymer melt is oxidized when it comes into contact with air over a distance referred to as the air gap. This distance can be optimized for each resin, with a typical range being 5 to 10 inches. Increasing the air gap may improve adhesion through longer oxidation time; however, too high of an air gap will result in lower adhesion from excessive cooling of the polymer. When the melt exits the die the melt film is pulled down into a nip (55) between two rollers (56) and (57), the pressure roll and the chill roll, respectively, situated below the die. The substrates, moving at a velocity which is higher than that of the melt film, draw the film to the required thickness. The pressure between the two rolls forces the film onto the substrates. Further, the film is cooled and solidified by the low temperature of the chill roll, typically at around 50 to 85° F. The draw-down ratio, which is one of the characteristic parameters of the extrusion coating process, is the ratio of the die gap to the thickness of the polymer film on the substrate. A typical draw-down ratio is 20-60. The laminated film is then conveyed through various additional rollers, represented by (58) and (59) and collected on a final roll (60). A representative extrusion coating process is given, for instance, in Crystalline Olefin Polymers, Part II, by R.A.V. Raff and K. W. Doak (Interscience Publishers, 1964), pages 478 to 484, or Plastics Processing Data Handbook, by Dominick V. Rosato (Chapman & Hall, 1997), pages 273 to 277.

The films of the invention provide the advantage of being capable of forming a resealable lidding for a container, which lidding can comprise the entire surface closure of the container, without the need for die-cutting. Moreover, the presence of the internal polyurethane layer (c), rather than functioning as a haptic or “soft touch” coating intended to modify the surface feel of the film, provides a tamper-evident feature, as when the lid is opened for the first time, the film transitions from clear to cloudy. Layer (c) may further include a dye to enhance this effect.

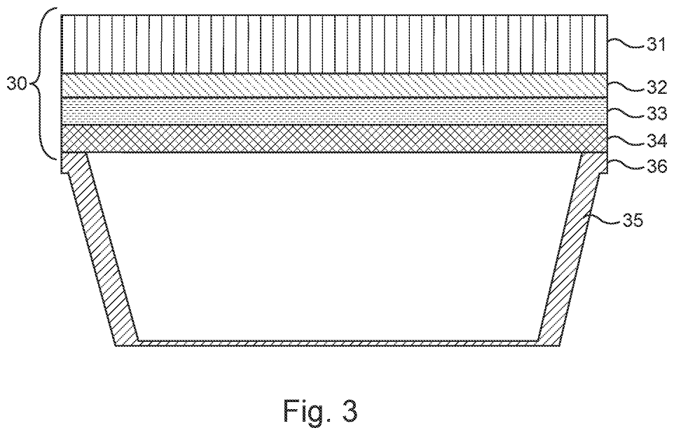

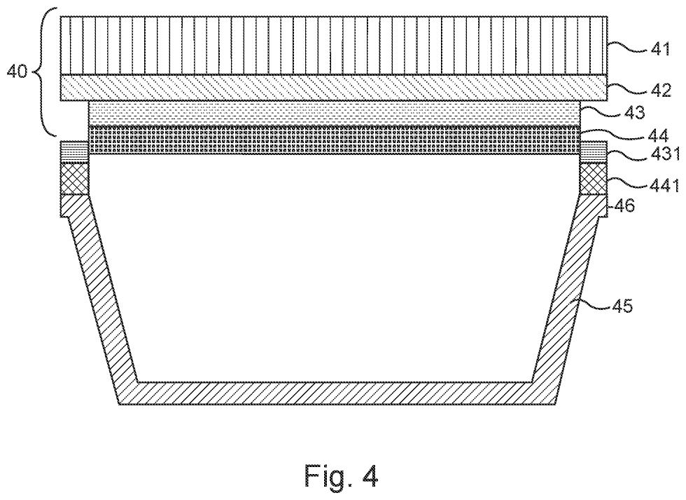

A container in accordance with the invention is represented by FIGS. 3 and 4. FIG. 3 shows the sealed container before opening (and after resealing). In FIG. 3, the multilayer film of the invention is represented by (30), made up of the printable BOPET (31), which is adhered by PSA (32) to the elastic polyurethane layer (33), adjacent to the heat sealable BOPET (34) which is heat-sealed to the lip (36) of container (35). In FIG. 4, the container has been opened by peeling back the lid which is represented by (40), and printable BOPET (41), PSA (42), polyurethane (43) and BOPET (44). The portion of the film heat-sealed to the lip (46) of the container (45) contains the remaining portion of the lid which stays adhered thereto, tamper-evident polyurethane (431), and BOPET (441).

### ASPECTS OF THE INVENTION

1. A multilayer film comprising, in this order:
   (a) a biaxially oriented polyethylene terephthalate layer,
   (b) a pressure sensitive adhesive layer,
   (c) an elastic polyurethane layer, and
   (d) a biaxially oriented polyethylene terephthalate layer.
2. The film of aspect 1, wherein (d) has the structure A:B:A:C; A and B comprise crystalline PET and antiblocking particles and C is an amorphous, heat-sealable copolyester.
3. The film of aspect 2, wherein the amorphous, heat-sealable copolyester is an ethylene terephthalate copolymer.
4. The film of aspects 2 or 3, wherein C is a copolymer of (i) dimethyl terephthalate or terephthalic acid with one or more of azelaic acid, dimethyl azelate, dimethyl sebacate, sebacic acid, isophthalic acid, or 5-sodiumsulfoisophthalic acid, or (ii) of dimethyl terephthalate or terephthalic acid with ethylene glycol, diethylene glycol and/or cyclohexanedimethyl glycol.
5. The film of any of aspects 2-4, wherein the antiblocking particles are silica, calcium carbonate, glass beads, kaolin, or a mixture of at least two thereof.
6. The film of any of aspects 1-5, wherein (d) has been biaxially stretched TD/MD 300-400%, at 226-238° C.
7. The film of any of aspects 2-6, wherein layers (A) and (B) together have a thickness of 2-100 urn, and layer (C) has a thickness of 0.1-10 μm, and layer (d) has a thickness of 2-110 μm.
8. The film of any of aspects 1-7, wherein layer (d) has a thickness of 8 urn.
9. The film of any of aspects 1-8, wherein layer (b) comprises at least one styrene block copolymer of at least one styrene monomer and isoprene, butadiene, butylene or a mixture thereof.
10. The film of aspect 9, wherein layer (b) comprises a styrene block copolymer of at least one styrene monomer and isoprene forming an SIS block copolymer.
11. The film of any of aspects 1-10, wherein layer (b) comprises 40-85% of styrene block copolymer and 10-35% of a compatible tackifying resin having a softening temperature of 5-150° C.
12. The film according to any of aspects 1-11, wherein the pressure sensitive adhesive has a viscosity, at a temperature of at least 130° C., lying within a range located above the power curve η=22 000×(dy/dt+200)^{-0.82} wherein dy/dt comprises a shear rate between 100 and 1,000 s⁻¹, a tensile strength at a poll rate of 1 ms⁻¹ lying within the range located below the polynomial curve y=−2.82×10⁻¹⁶ x⁵+5.92×10⁻¹³ x⁵−4.97×10⁻¹⁰ x⁴+2.15×10⁻⁷ x³−4.99×10⁻⁵ x²+6.26×10⁻³ x+4.71×10⁻², wherein y comprises an ordinate representing the stress expressed in MPa and x comprises an abscissa representing the deformation expressed in %; and an elastic modulus G′<5×10⁵ Pa at −20 to +40° C.
13. The film according to any of aspects 1-12, further comprising between layer (a) and layer (b), a layer (a′) of an additional copolyester.
14. The film according to any of aspects 2-13, wherein layer (C) comprises an anti-fog agent.
15. A container having a resealable lid, wherein said lid is a film according to any of aspects 1-14.
16. A process for the preparation of a film according to any of aspects 1-14, comprising coextrusion of layer (d), heating to above glass transition temperature, biaxially stretching the layer, gravure coating of the layer (c) polyurethane dispersion on layer (d), and extrusion laminating layer (d) to layer (a) with layer (b) PSA as the adhesive.
17. The process according to aspect 16, wherein layer (d) is biaxially stretched at 238° C.
18. The process according to aspect 16 or 17, further comprising (i) a corona pretreatment of layer (a) prior to supply of layer (a) to an extrusion lamination apparatus, (ii) a bump corona treatment where a corona treater is present on the production line and effects treatment prior to application of adhesive and lamination, or a combination of (i) and (ii).

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The entire disclosures of all applications, patents and publications, cited herein are incorporated by reference herein.

Unless explicitly noted otherwise, all percentage data for mixtures denote percent by weight, and relate to the corresponding mixture as a whole, comprising all solid or liquid components, without solvents. Furthermore, unless explicitly noted otherwise, all temperatures are indicated in in degrees Celsius (° C.). The following examples are intended to explain the invention without limiting it.

### EXAMPLES

A series of film samples were created to test the suitability of the resulting film having this structure

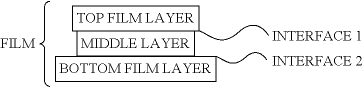

for a resealable lidding film for packaging containers.

### Top Film Layer

Film A: 92 gauge (23.3 μm) multilayer biaxially oriented PET film with a Corona treated surface on one side (“Corona Side”) and a coextruded copolyester on the opposite side (“COEX Side”).

### Middle Layer

PSA: Extrudable pressure sensitive adhesive.

### Bottom Film Layer

Film B: 50 gauge (12.7 μm) multilayer biaxially oriented PET film with a coextruded copolyester heat sealable layer that includes a slip package on one side (“Heat Seal Side with Slip”) and a Corona treated surface on the opposite side (“Corona Side”).

Film C: 52 gauge (13.2 μm) multilayer biaxially oriented PET film with a haptic (“soft touch”) matte coating on one side (“Soft Touch Side”) and a coextruded copolyester heat sealable layer on the opposite side (“Coex Side”).

Film D: 48 gauge (12.2 μm) multilayer biaxially oriented PET film with a coextruded matte surface on one side (“Matte Side”) and a Corona treated surface on the opposite side (“Corona Side”).

Film E: 48 gauge (12.2 μm) multilayer biaxially oriented PET film that has been chemically treated on one side (“Chemically Treaded Side”) and a coextruded copolyester on the opposite side (“Coex Side”).

Film F: 48 gauge (12.2 μm) multilayer biaxially oriented PET film with a very smooth, high coefficient of friction surface on one side (“Smooth Side”) and a coextruded copolyester on the opposite side (“Coex Side”).

Film G: 53 gauge (13.5 μm) multilayer biaxially oriented PET film with a coextruded copolyester heat sealable layer on one side (“Heat Seal Side”) and a soft touch (haptic) matte coating on one side (“Soft Touch Side”).

Film H: 37 gauge (9.4 μm) multilayer biaxially oriented PET film with a coextruded copolyester heat sealable layer on one side (“Heat Seal Side”) and a Corona treated surface on the opposite side (“Corona Side”) with multidirectional ‘easy tear’ property.

Film I: 72 gauge (18.3 μm) multilayer biaxially oriented PET film that has a dead-fold property with a Corona treated surface on one side (“Corona Side”) and an untreated plain PET surface on the opposite side (“Plain Side”).

Film J: 56 gauge (14.2 μm) multilayer biaxially oriented PET film with multidirectional ‘easy-tear’ property as described in U.S. Pat. No. 7,943,230.

### Samples

Film A was used for the Top Film Layer for all Samples, with the Corona Side of Film A oriented towards the Middle Layer at Interface 1 for the first eight (8) Samples and the COEX Side oriented towards the Middle Layer at Interface 1 for the next seventeen (17) Samples.

The same PSA was used for the Middle Layer, but with different thicknesses.

Films B-J were used for the Bottom Film Layer with different sides oriented towards the Middle Layer at Interface 2.

For each Sample, the Film for the Top Film Layer and the Film for the Bottom Film Layer were fed to a nip into which the PSA for the Middle Layer was extruded as illustrated in FIG. 5. Extrusion was at a temperature of 170° C., over an air gap to the nip of 7 inches, with the chill roll at 70° F.

Table I summarizes the combinations of films, film orientations, and middle layer thicknesses that were used to create the Samples.

TABLE I
SUMMARY OF SAMPLES

| | Side of Top | | Bottom | Side of Bottom |
|---|---|---|---|---|
| | Layer @ | Middle Layer | Layer | Layer @ |
| Sample | Interface 1 | Thickness (μm) | Film | Interface 2 |
| 1 | Corona | 6.8 | D | Corona |
| 2 | Corona | 6.8 | D | Matte |
| 3 | Corona | 13.5 | C | Soft Touch |
| 4 | Corona | 10.2 | C | Soft Touch |
| 5 | Corona | 13.5 | B | Heat Seal with Slip |
| 6 | Corona | 10.2 | B | Heat Seal with Slip |
| 7 | Corona | 10.2 | F | Smooth |
| 8 | Corona | 10.2 | E | Chemically Treated |
| 9 | COEX | 10.2 | E | Chemically Treated |
| 10 | COEX | 10.2 | E | Coex |
| 11 | COEX | 10.2 | D | Corona |
| 12 | COEX | 13.5 | C | Soft Touch |
| 13 | COEX | 10.2 | C | Soft Touch |
| 14 | COEX | 10.2 | B | Heat Seal |
| 15 | COEX | 10.4 | G | Soft Touch |
| 16 | COEX | 14.6 | G | Soft Touch |
| 17 | COEX | 7.3 | G | Soft Touch |
| 18 | COEX | 33.1 | G | Soft Touch |
| 19 | COEX | 25.4 | G | Soft Touch |
| 20 | COEX | 19.0 | G | Soft Touch |
| 21 | COEX | 19.0 | I | Corona |
| 22 | COEX | 19.0 | J | Plain PET |
| 23 | COEX | 25.4 | I | Corona |
| 24 | COEX | 15.6 | H | Corona |
| 25 | COEX | 13.1 | H | Corona |

Samples 1-14 were evaluated as to suitability for a resealable film (on container) application, as determined by Peel Strength, Haze, and Clarity. The tamper evident feature (changing from clear to cloudy when peeled and resealed for the first time) is provided by Samples 3, 4, 12 and 13 (those with the Soft Touch Coating at Interface 2). The Soft Touch Coating listed in Table 1 is a coating of layer (c), namely from an elastic polyurethane dispersion.

Samples 15-20 show the effect of the amount of PSA used in the middle layer on Peel Strength, Haze and Clarity.

Samples 21 and 23 show the effect of Film l's dead-fold property due to lack of biaxial orientation (only partially oriented to make it ‘twistable’) on the tear-ability of the bottom film layer.

Sample 22 shows the effect of Film J's tear-ability on the structure's performance as it is desirable for the bottom film layer to break cleanly upon the first opening.

Samples 24 and 25 show the effect of BOPET layer (d) as the bottom film layer, but without the haptic (soft touch) coating of layer (c).

### Test Method for Peel Strength

Samples that did not have an outer heat sealable surface (samples 1-14) were coated (about 2 gsm coat weight) on the bottom film layer outer surface with a copolyester heat sealable resin dissolved in 1,3 dioxolane solvent and dried in an oven for 5 minutes.
1″ wide strips were cut from the film samples and from 0.5 mm APET tray stock.
The heat sealable side of the film samples were heat sealed to the APET tray pieces at 200° C. with 1.5 second dwell time and 40 psi applied pressure using a Labthink Param Classic 513 Gradient Heat Sealer.
The Peel Strength was measured using an MTS Insight 1 tensile device. The film was held in the upper jaw and the tray piece was held in the lower jaw. The sample was peeled at 50 mm/min at 180°.
After peeling, the film was removed from jaws and resealed by pressing the film back onto the tray piece with the tester's thumb 4 times.
Then the sample was re-peeled using the same method.
This was repeated for 4 peels.

The Peel Strength testing results are summarized in Table II below.

TABLE II
SUMMARY OF PEEL STRENGTH TESTING

| | 1^{st} Peel | 2^{nd} Peel | 3^{rd} Peel | 4^{th} Peel |
|---|---|---|---|---|
| | Strength | Strength | Strength | Strength |
| Sample | (gf/in) | (gf/in) | (gf/in) | (gf/in) |
| 1 | 504 | 0 | 0 | 0 |
| 2 | 562 | 432 | 378 | 207 |
| 3 | 1384 | 590 | 430 | 323 |
| 4 | 1466 | 999 | 810 | 269 |
| 5 | 1356 | 444 | 390 | 409 |
| 6 | 748 | 249 | 246 | 209 |
| 7 | 708 | 502 | 315 | 286 |
| 8 | 785 | 393 | 351 | 302 |
| 9 | 1495 | 713 | 523 | 506 |
| 10 | 1433 | 724 | 472 | 387 |
| 11 | 659 | 0 | 0 | 0 |
| 12 | 1449 | 628 | 480 | 434 |
| 13 | 1347 | 1253 | 668 | 681 |
| 14 | 751 | 369 | 413 | 283 |
| 15 | 1288 | 517 | 375 | 350 |
| 16 | 1558 | 550 | 372 | 332 |
| 17 | 1137 | 267 | 173 | 169 |
| 18 | 1816 | 675 | 566 | 428 |
| 19 | 1560 | 623 | 565 | 402 |
| 20 | 1446 | 757 | 546 | 380 |
| 21 | 1557 | 697 | 592 | 523 |
| 22 | 906 | 0 | 0 | 0 |
| 23 | 1683 | 708 | 629 | 564 |
| 24 | 1371 | 683 | 544 | 544 |
| 25 | 1049 | 485 | 401 | 37 |

It is desirable for the 1^{st} Peel Strength to be greater than 1140 gf/in for adhesive failure and for the 2^{nd} Peel Strength to be greater than 285 gf/in for adhesive failure.

The Samples were also tested for Haze and Clarity. Haze was tested using a BYK Gardner haze-gard plus following ASTM method D 1003. The same device was used to measure Clarity. The Haze and Clarity testing results are summarized in Table III below.

TABLE III
SUMMARY OF HAZE & CLARITY TESTING

| Sample | Haze(%) | Clarity (%) |
|---|---|---|
| 1 | 41.6 | 68.4 |
| 2 | 45.3 | 73.7 |
| 3 | Not Tested | Not Tested |
| 4 | 14.6 | 85.4 |
| 5 | Not Tested | Not Tested |
| 6 | 9.5 | 88.6 |
| 7 | 8.3 | 86.2 |
| 8 | 6.9 | 87.0 |
| 9 | 7.9 | 89.9 |
| 10 | 6.2 | 91.4 |
| 11 | 41.4 | 69.4 |
| 12 | Not Tested | Not Tested |
| 13 | 10.6 | 90.3 |
| 14 | 9.9 | 90.7 |
| 15 | 10.2 | 83.0 |
| 16 | 9.1 | 83.7 |
| 17 | 13.8 | 81.6 |
| 18 | 9.0 | 83.9 |
| 19 | 8.8 | 84.2 |
| 20 | 8.7 | 83.8 |
| 21 | 6.9 | 90.0 |
| 22 | 5.9 | 90.3 |
| 23 | 6.9 | 90.1 |
| 24 | Not Tested | Not Tested |
| 25 | Not Tested | Not Tested |

It is desirable to have a Haze value of ≤13.0% and a Clarity value of ≥88.2%

1. A multilayer film comprising, in this order:
(e) a biaxially oriented polyethylene terephthalate layer,
(f) a pressure sensitive adhesive layer,
(g) an elastic polyurethane layer, and
(h) a biaxially oriented polyethylene terephthalate layer.

2. The film of claim 1, wherein (d) has the structure A:B:A:C; A and B comprise crystalline PET and antiblocking particles and C is an amorphous, heat-sealable copolyester.

3. The film of claim 2, wherein the amorphous, heat-sealable copolyester is an ethylene terephthalate copolymer.

4. The film of claim 3, wherein C is a copolymer of (i) dimethyl terephthalate or terephthalic acid with one or more of azelaic acid, dimethyl azelate, dimethyl sebacate, sebacic acid, isophthalic acid, or 5-sodiumsulfoisophthalic acid, or (ii) of dimethyl terephthalate or terephthalic acid with ethylene glycol, diethylene glycol and/or cyclohexanedimethyl glycol.

5. The film of claim 2, wherein the antiblocking particles are silica, calcium carbonate, glass beads, kaolin, or a mixture of at least two thereof.

6. The film of claim 1, wherein (d) has been biaxially stretched TD/MD 300-400%, at 226-238° C.

7. The film of claim 2, wherein layers (A) and (B) together have a thickness of 2-100 μm, and layer (C) has a thickness of 0.1-10 μm, and layer (d) has a thickness of 2-110 μm.

8. The film of claim 7, wherein layer (d) has a thickness of 8 μm.

9. The film of claim 1, wherein layer (b) comprises at least one styrene block copolymer of at least one styrene monomer and isoprene, butadiene, butylene or a mixture thereof.

10. The film of claim 9, wherein layer (b) comprises a styrene block copolymer of at least one styrene monomer and isoprene forming an SIS block copolymer.

11. The film of claim 9, wherein layer (b) comprises 40-85% of styrene block copolymer and 10-35% of a compatible tackifying resin having a softening temperature of 5-150° C.

12. The film according to claim 11, wherein the pressure sensitive adhesive has a viscosity, at a temperature of at east 130° C., lying within a range located above the power curve η=22 000×(dy/dt+200)^{-0.82} wherein dy/dt comprises a shear rate between 100 and 1,000 s⁻¹, a tense strength at a pull rate of 1 ms⁻¹ lying within the range located below the polynomial curve y=−2.82×10⁻¹⁶ x⁶+5.92×10⁻¹³ x⁵−4.97×10⁻¹⁰ x⁴+2.15×10⁻⁷ x³−4.99×10⁻⁵ x²+6.26×10⁻³ x+4.71×10⁻², wherein y comprises an ordinate representing the stress expressed in MPa and x comprises an abscissa representing the deformation expressed in %; and an elastic modulus G′<5×10⁵ Pa at −20 to +40° C.

13. The film according to claim 1, further comprising between layer (a) and layer (b), a layer (a′) of an additional copolyester.

14. The film according to claim 2, wherein layer (C) comprises an anti-fog agent.

15. A container having a resealable lid, wherein said lid is a film according to claim 1.

16. A process for the preparation of a film according to claim 1, comprising coextrusion of layer (d), heating to above glass transition temperature, biaxially stretching the layer, gravure coating of the layer (c) polyurethane dispersion on layer (d), and extrusion laminating layer (d) to layer (a) with layer (b) PSA as the adhesive.

17. The process according to claim 16, wherein layer (d) is biaxially stretched at 238° C.

18. The process according to claim 16, further comprising (i) a corona pretreatment of layer (a) prior to supply of layer (a) to an extrusion lamination apparatus, (ii) a bump corona treatment where a corona treater is present on the production line and effects treatment prior to application of adhesive and lamination, or a combination of (i) and (ii).
